(19) United States
(12) Patent Application Publication
(10) Pub. No.: US 2005/0068523 A1
(43) Pub. Date: Mar. 31, 2005

(54) Calibration block and method for 3D scanner

(75) Inventors: Wei-Ping Wang, Arlington, MA (US); Qing Tang, Granby, CT (US); Lei Zhao, Carlisle, MA (US)

Correspondence Address: Yoon S. Ham, Esq.;Piper Rudnick LLP, P.O. Box 9271, Reston, VA, 20195, US

(73) Assignee: Multi-Dimension Technology, LLC

(21) Appl. No.: 10/915,909

(22) Filed: Aug. 11, 2004

Related U.S. Application Data
(60) Provisional application No. 60/494,160, filed on Aug. 11, 2003.

(51) Int. Cl. G01B 11/24

(52) U.S. Cl. 356/243.1

(57) ABSTRACT

The present invention is directed to a calibration block for use in calibrating a 3D scanner, a scanner system including the calibration block, and the use of the calibration block to calibrate a scanner which includes 2 cameras and a line generator which are in a fixed relationship to each other.

### BACKGROUND OF THE INVENTION

The potential applications for 3D scanning technology are immense. Three-dimensional modeling is strongly and increasingly demanded in the engineering, medicine, veterinary medicine, film and television, clothing and textiles and entertainment. One popular approach to obtain 3D modeling is by non-contact 3D optical scanning.

There are several types of optical object shape scanners, which fall into two basic categories: systems based on triangulation and silhouetting. The present invention is directed to scanner systems based on triangulation.

A triangulation system projects beams of light on an object and then determines three-dimensional spatial locations for points where the light reflects from the object. Ordinarily, the reflected light bounces off the object at an angle relative to the light source. The system collects the reflection information from a location relative to the light source and then determines the coordinates of the point or points of reflection by triangulation. A single dot system projects a single beam of light which, when reflected, produces a single dot of reflection. A scan line system sends a plane of light against the object which projects on the object on a line and reflects as a curvilinear-shaped set of points describing one contour line of the object. The location of each point in that curvilinear set of points can be determined by triangulation.

Some single dot optical scanning systems use a linear reflected light position detector to read information about the object. In such systems a laser projects a dot of light upon the object. The linear reflected light position detector occupies a position relative to the laser that allows the determination of a three dimensional location for the point of reflection. A single dot optical scanner with a linear reflected light position detector could digitize only a single point at a time. Thus, a single dot optical scanning system, like the mechanical system described above, is relatively slow in collecting a full set of points to describe an object. Single dot optical scanners are typically used for applications such as industrial engineering. The digitizing speed is usually slow and is limited by the mechanics of the scanning system, i.e., the moving and positioning of the light beam. However, accuracy of these systems can be high. A scanning head can be mounted on a high precision, but costly, positioning system to take a digitized image of an object with generally good accuracy. However, because of the high cost, slow speed, and lack of flexibility, single dot optical scanners find generally only limited application.

Scan line systems offer one solution to the speed time bottleneck of single point triangulation system. Such systems typically employ a 2D imager, e.g. a charged coupled device (CCD) camera, for signal detection. The systems project a light plane (i.e. a laser stripe) instead of just one dot and then read the reflection of multiple points depicting the contour of an object at a location that is a distance from the CCD camera and from which the position can be triangulated. Some embodiments of the scan line-type system attach the CCD camera to a rotating arm or a moving platform. During scanning, either the object moves on a known path relative to the camera and laser, or the camera and laser, together, move around the object. In any case, such systems usually depend on this type of fixed rotational movement and typically use a bulky, high-precision mechanical system for positioning. Because of the use of mechanical positioning devices, resealing flexibility can be very limited, e.g. a scanner designed for objects the size of a basketball may not be useful for scanning apple-sized objects.

Some laser stripe triangulation systems currently available are further limited because the laser stripe stays at a fixed angle relative to the camera and the system makes its calculations based on the cylindrical coordinates of its rotating platform. The mathematical simplicity in such a projection system complicates the hardware portion of these devices as they typically depend on the rotational platform mentioned. Also, the simplified geometry does not generally allow for extremely refined reproduction of topologically nontrivial objects, such as objects with holes in them (e.g. a tea pot with a handle). Full realization of triangulation scanning with a non-restrictive geometry has not been achieved in the available devices.

In general, speed, accuracy, and cost have been recurrent and difficult to achieve goals for device devices that scan, measure or otherwise collect data about 3D objects for purposes such as reproduction. Neither triangulation nor silhouetting meet the requirements of speed and accuracy simultaneously.

Thus, for devices that scan, measure or otherwise collect data about an object, it would be a substantial advance if a scanner could be created that could rapidly gather highly accurate data concerning a 3D object.

It would also be an advance if the device could rapidly process the data in a fashion that did not require a large computing system (thereby allowing for portable versions), and after computing, create a descriptive model from the data points collected about the object.

Conventional methods for calibrating a camera include (1) a calibration method using a 3D calibration object, e.g. a rectangular parallelopiped, (2) a self-calibration method, and (3) a calibration method using coordinates of points on a two-dimensional plane. None of these have been sufficiently satisfactory and thus work has continued to find better ways to do the necessary calibrations. Some more recent attempts have included U.S. patent application Ser. No. 2002/0186897A1 which uses a concentric circle pattern and U.S. patent application Ser. No. 2003/0202691A1 which utilizes a cube on a rotating turntable.

### SUMMARY OF THE PRESENT INVENTION

The present invention is directed to a 3D scanner calibration block having 4 side faces, a top and a bottom, wherein each of two abutting side faces contains five planar sections arranged so that (i) two non-abutting planar sections are perpendicular to the bottom; (ii) two abutting planar sections are perpendicular to each other and neither is perpendicular to the bottom, (iii) a planar section is parallel to one of non-perpendicular-to-the-bottom planar sections; and (iv) one of the abutting side faces further includes a camera calibration grid at a known location and perpendicular to the bottom. Preferably the camera calibration grid is located such that a camera can move along the X axis to view an intersection line between one of the perpendicular-to-the bottom planar sections and one of the non-perpendicular-to-the-bottom planar sections.

The present invention is further directed to the use of the calibration block in combination with 2 cameras and a straight line generator to calibrate a 3D scanner. Preferably a laser straight line generator is used.

The present invention is further directed to a 3D scanner which includes two cameras, a laser line generator, means to simultaneously move the cameras and laser line generator along their X axis, means to simultaneously move the cameras and laser line generator along their Z axis, a rotating object-holding table, means to move the rotating object-holding table along its Y axis, and a calibration block.

### BRIEF DESCRIPTION OF THE DRAWINGS

FIG. 1 is an isometric drawing of a 3D scanner of this invention.

FIG. 2 is a drawing of a calibration block of this invention showing 2 abutting side faces and the top face.

FIG. 3 is a preferred camera calibration grid.

FIG. 4 is a section of the calibration block of FIG. 2 showing a laser line generated on 2 surfaces.

FIG. 5 is a section of the calibration block of FIG. 2 showing laser lines generated on three surfaces.

FIG. 6 shows the relationship between 2 cameras, a laser line generator, and a calibration block, and the different images the left and right cameras when focusing upon a location between the cameras.

FIG. 7 shows the relationship between 2 cameras, a laser line generator, and a calibration block, and the different images the left and right cameras when focusing upon a location to the right of both cameras along the X axis.

### DESCRIPTION OF THE PREFERRED EMBODIMENTS

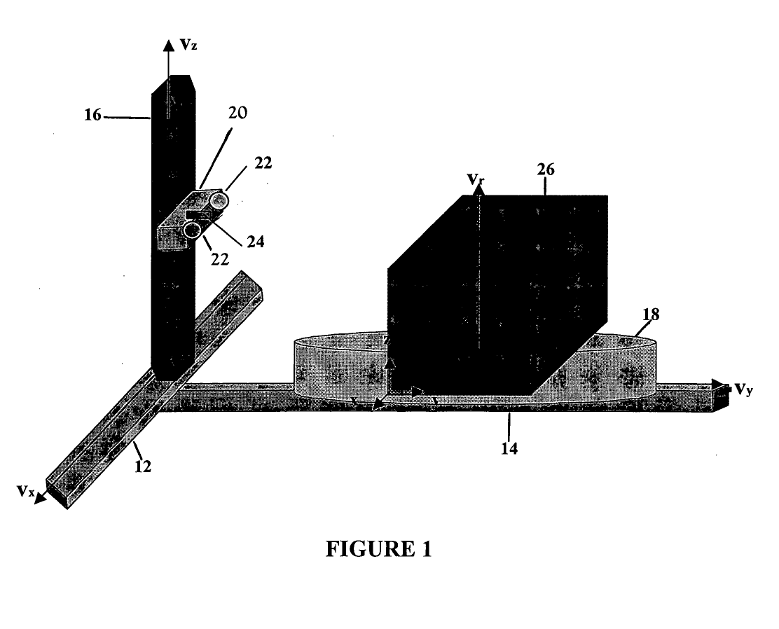

FIG. 1 shows a 3D scanner system 10 in accordance with the present invention. The system structure shown has four motion modules: an X table 12, a Y table 14, a Z table 16 and a rotation table 18. The X table 12 and Y table 14 are perpendicular to each other, but are otherwise unconnected. The Z table 16 is attached to the X table 12, so that the Z axis is vertical. When the X table 12 moves, the Z table 16 moves along with it. A camera/laser module 20 which includes two cameras 22 and a laser line generator 24 is attached to the Z table 16 and can move up/down. Thus with the motion of the X table 12 and Z table 16, the camera/laser module 20 can scan in the X and Z planes. The rotation table 18 is assembled on top of the Y table 14.

The present invention is further directed to a 3D scanner calibration block 26 having four side faces, a top and a bottom, wherein two abutting side faces each contain five planar sections organized as follows: (i) two non-abutting planar sections are perpendicular to the bottom; (ii) two abutting planar sections are perpendicular to each other and neither is perpendicular to the bottom, (iii) a planar section is parallel to one of non-perpendicular-to-the-bottom planar sections; and wherein one of the abutting sides further includes a camera calibration grid at a known location and perpendicular to the bottom. Preferably the camera calibration grid is located such that a camera can move along the X axis to view an intersection line between one of the perpendicular-to-the bottom planar sections and one of the non-perpendicular-to-the-bottom sections.

The present invention is further directed to the use of the calibration block in combination with 2 cameras and a straight line generator to calibrate a 3D scanner. Preferably a laser straight line generator is used.

The present invention is further directed to a 3D scanner which includes two cameras, a laser line generator, means to simultaneously move the cameras and laser line generator along their X axis, means to simultaneously move the cameras and laser line generator along their Z axis, a rotating object-holding table, means to move the rotating object-holding table along its Y axis, and a calibration block.

A 3D scanner such as that shown in FIG. 1 needs to be calibrated for its optical and mechanical characteristics before its operation. Such characteristics are described by the following parameters:
1 Camera internal optical parameters:
   a) Scale: Cx,Cy,
   b) Center: Xc,Yc, and
   c) Distortion parameter (k1 and k2 for non-linear mode, optional)
2 Camera exterior parameters and its relationship with laser line generator:
   a) Orientation of camera optical axis: Tx, Ty, Tz
   b) Displacement between camera and laser line generator: Td
3. X-table orientation with respect to the world coordinate system depicted by an orientation vector
   a) [(Vx)x, (Vx)y, (Vx)z]; (only 2 components are independent)
   b) Nominal value is (1, 0, 0)
4. Y-table orientation with respect to the world coordinate system
   a) [(Vy)x, (Vy)y, (Vy)z]; (2 independent parameters)
   b) Nominal value is (0, 1, 0)
5. Z-table orientation with respect to the world coordinate system
   a) [(Vz)x, (Vz)y, (Vz)z)]; (2 independent parameters)
   b) Nominal value is (0,0,1)
6. Rotation axis orientation of the turntable R
   a) [(Vr)x, (Vr)y, (Vr)z]; 2 independent parameters
   b) Nominal value (0,0,1)
7. Rotation axis offset of the turn table
   a) [x0, y0, z0]; 3 independent parameters
   b) Nominal value depends on configuration
8. Camera axis orientation (intermediate variables)
   a) (nx, ny, nz)

Calibration establishes the relationship between the system measurement and a real object. Thus, before a system can be used, it must be calibrated. The present invention provides a novel method and apparatus for calibrating a 3D scanner using a combination of (i) a calibration block in combination with (ii) 2 cameras and (iii) a line generator, wherein the 2 cameras and the line generator are maintained in a fixed relationship to each other.

### The Calibration Block

A critical element of the present invention is a calibration block which will allow the generation of all information needed to calibrate a 3-D scanner.

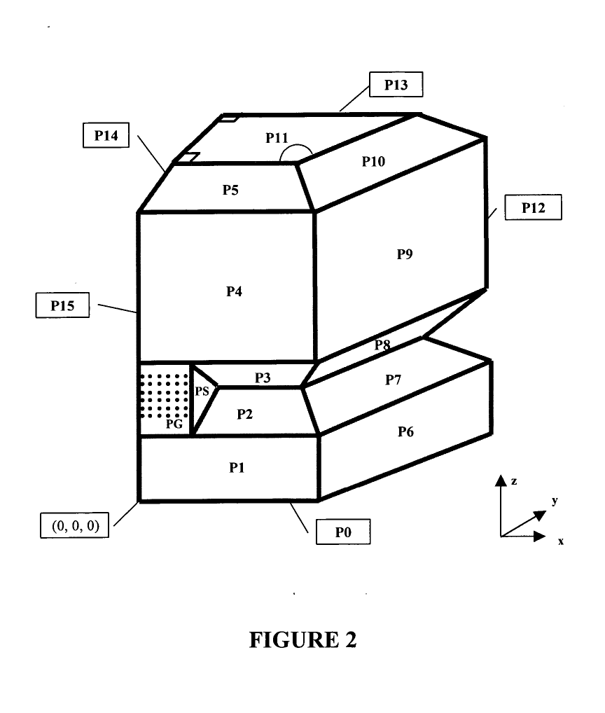

FIG. 2 shows a calibration block of the present invention. It is a rectangular solid body and prepared from any available hard material such as metal, plastic, or wood. The body has 6 faces—four sides, a top and a bottom. Two abutting sides and the top will be visible from a point when the other two sides and the bottom are hidden from view. The faces not shown in FIG. 2 are not critical to the present invention and thus will most commonly simply be flat surfaces that join to form a hidden corner.

The visible faces are machined to have planar sections with specific varying orientations as seen in FIG. 2 which shows such a structure.

Referring to FIG. 2, a first visible side face is perpendicular to the bottom face (P0) and includes at least 5 planar sections. This face includes: (i) two (2) separated planar sections (P1 and P4) perpendicular-to-the-bottom, (ii) two (2) abutting planar sections (P2 and P3) not-perpendicular-to-the-bottom, perpendicular to each other, and each abuts a separate one of the perpendicular sections (P1 and P4), and (iii) a planar section (P5) parallel to one of the not-perpendicular-to-the-bottom sections (P2).

A second visible side face abuts visible side face 1 and is perpendicular to the bottom face (P0). The second face includes: (i) 2 separate planar sections (P6 and P9) perpendicular-to-bottom (P0), (ii) 2 abutting planar sections (P7 and P8) not-perpendicular-to-the-bottom but perpendicular to each other and each abuts a different one of the perpendicular sections (P6, P9), (iii) a planar section (P10) parallel to one of the not-perpendicular-to-the-bottom sections.

The first and second visible faces are located side-by-side on the calibration block to form a corner and are at an angle of about 110 to 160 degrees to each other, preferably about 125 to 145 degrees, and most preferably about 135 degrees. This allows the two side faces to be viewable by both cameras by only moving X and Y. This allows calibration information of the Y axis (table) to be generated without rotation.

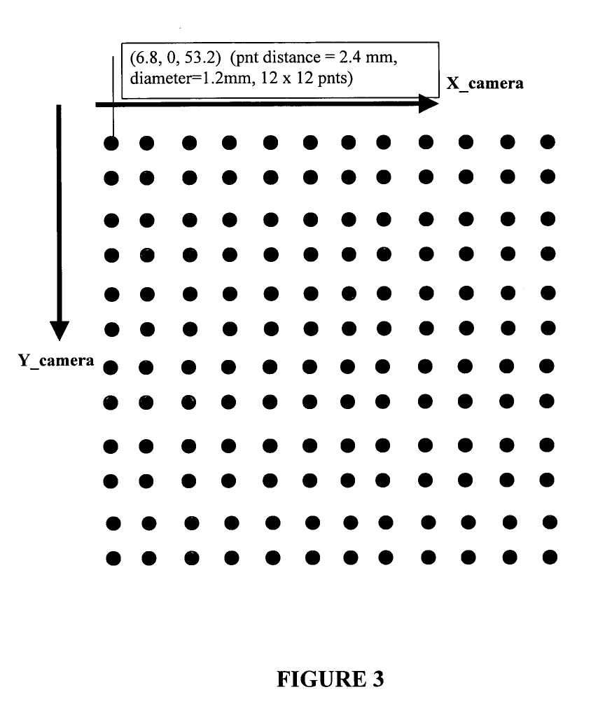

The first visible side face further includes a grid as shown in FIG. 3 for use as a camera calibration target. The camera calibration target can be any dot or line grid commonly used for calibrating camera parameters. As shown a 12×12 dot grid is camera calibration target. The position and orientation of the calibration grid relative to the zero point (0,0,0) and the bottom (P0) must be known. The face containing the camera calibration target is perpendicular to the bottom and is located either on one of the 2 separate perpendicular-to-the-bottom planar sections (P1, P4) or on an additional planar section in the same planar section (PG).

Most preferably the camera calibration target is located on the separate planar section (PG) located between the 2 perpendicular-to-the-bottom sections (P1, P4) next to the 2 not-perpendicular-to-the-bottom sections (P2, P3). This relationship permits the cameras to only move in X after taking images of the calibration grid to view the intersection lines P1/P2, P2/P3.

The visible top face (P11) is not used to do any calibration.

Most preferably, the planar sections forming the calibration block of this invention are organized as shown in FIG. 2 in which all surfaces are flat.

1. P1 and P4 are on the same face.

2. P6 and P9 are on the same face, and that is a different face from the face containing P1 and P4.

3. P1, P4, P6, P9, P12, and P15 are perpendicular to the bottom P0 of the standard.

4. The sizes of surfaces P2, P3, and top part of P1 are chosen such that they can all be seen in one view of a camera.

5. The sizes of surfaces P7, P8, and top part of P6 are chosen such that they can all be seen in one view of a camera.

6. The angle between P1 and P2 is about 135 degrees. The angle between P2 and P3 is about 90 degrees. The angle between P3 and P4 is about 135 degrees. The angle between P4 and P5 is about 135 degrees. The angles do not need to be exact.

7. The angle between P6 and P7 is about 135 degrees. The angle between P7 and P8 is about 90 degrees. The angle between P8 and P9 is about 135 degrees. The angle between P9 and P10 is about 135 degrees. The angles do not need to be exact.

8. The angle between P1 and P6 is about 135 degrees, as is the angle between P4 and P9. The angles do not need to be exact, but they must be known to within about 1 degree.

9. The angle between P1 and P15 is about 90 degrees.

10. The angle between P4 and P15 is about 90 degrees.

11. The angle between P14 and P15 is about 135 degrees.

12. Surface PG is on either the same plane as P1 and P4 or P6 and P9. A camera calibration target is located on PG. Alternatively, the camera calibration target may be on any of P1, P4, P6 or P9 provided that its location is known.

13. Surfaces PS and P11 are not used for calibration purposes.

While the calibration block may be of any desired size, generally it can be about 300×300×300 mm³. While there is no special requirement for the color of the surfaces or the calibration dot grids as long as they provide good contrasting camera images, the block is generally dark black with white dots in the grid pattern. Alternatively, the block may be white (or another light color) and the dots dark black. The calibration block is shown in FIG. 2 as a single block, but it may be formed from two or more pieces accurately joined together.

### Using the Calibration Block

Two different sensors are used in combination with the calibration block for the calibration—2 cameras (left and right) and a laser line generator. Although the optical properties of cameras, their positions and orientations need to be calibrated, that calibration is well known and thus is not part of the present invention. The cameras are being used here effectively as fixed detectors to give relative information about the external environment. For example, a camera can tell whether one image pattern is the same as another and it can tell which pattern is higher or which pattern is to the right.

With a laser line projected onto a target, the fixed triangular relationship among the laser source and the cameras can give relative depth information about an object. For example, by checking the laser line images on two surfaces, one can tell which a surface is closer to the laser/camera setup.

For a fixed setup, direct camera scaling (pixel/mm) is obtainable. For example, take a camera view of the four dots on the standard bar, one can calculate the direct camera scales in X and Y for that fixed distance. So, if there is no distance change, the position of dots in the camera view can also tell disposition. This may be used as alternate measure.

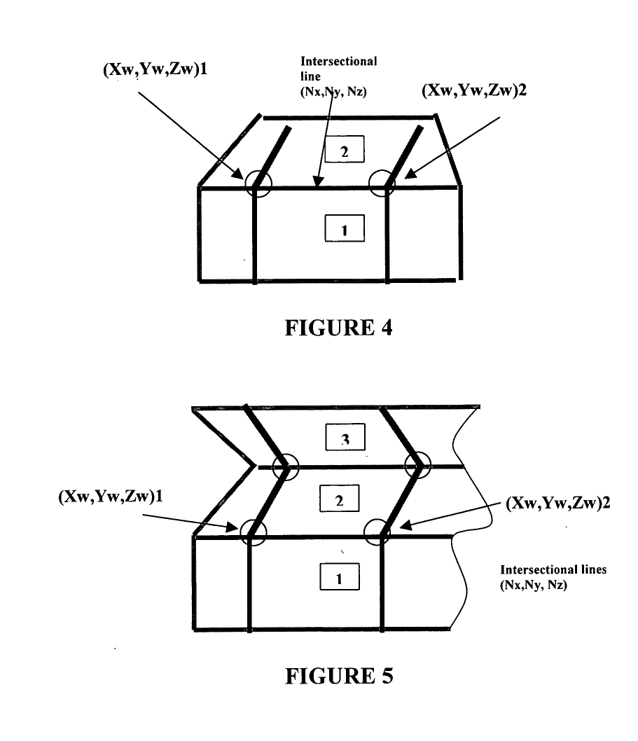

FIGS. 4 and 5 show images with laser lines on two and three surfaces of the calibration block. By using the cameras to get images of the laser lines, the intersection points of the laser lines can be found. These points tell the intersection position of the two or three surfaces of the calibration block in the camera's vision view. By using the information, the relationship between the real system, and the 2-camera vision system can be established.

Calibration initialization begins with moving all axes to their home positions. The home position of all axes may vary slightly from machine to machine, but can be adjusted to be within a required range.

After system homing, the application moves all axes to a known calibration position (based on configuration). This position can also be the same as system initial position wherein: (i) the rotating table upon which the calibration block is placed is placed parallel to the X-axis, (ii) the X-axis position is at the center; (iii) the Y-axis is positioned so that the table is at nominal working distance; and (iv) the Z-axis is positioned to be its lower end.

The calibration block is placed close to the center of the table, and in parallel with the X-axis. This is a rough requirement and does not need to be accurate. The scanner is preferably provided with a home position that is very repeatable and with marks on the table to mark the desired calibration block position.

After the calibration block is placed on the turntable, the system moves along the X axis to two positions. At each position, one camera (left or right) is used to check the position of the laser line on a surface, e.g. P1. If the calibration block 26 is parallel to the X table 12, then the camera image of the laser line will not move when the X table 12 moves along the X axis. If the laser line position shifts (left or right) in the vision images, the block is not parallel and adjustment is made. Based on the position shift, the system then rotates the turntable 18 to place the calibration block 26 parallel to the X table 12.

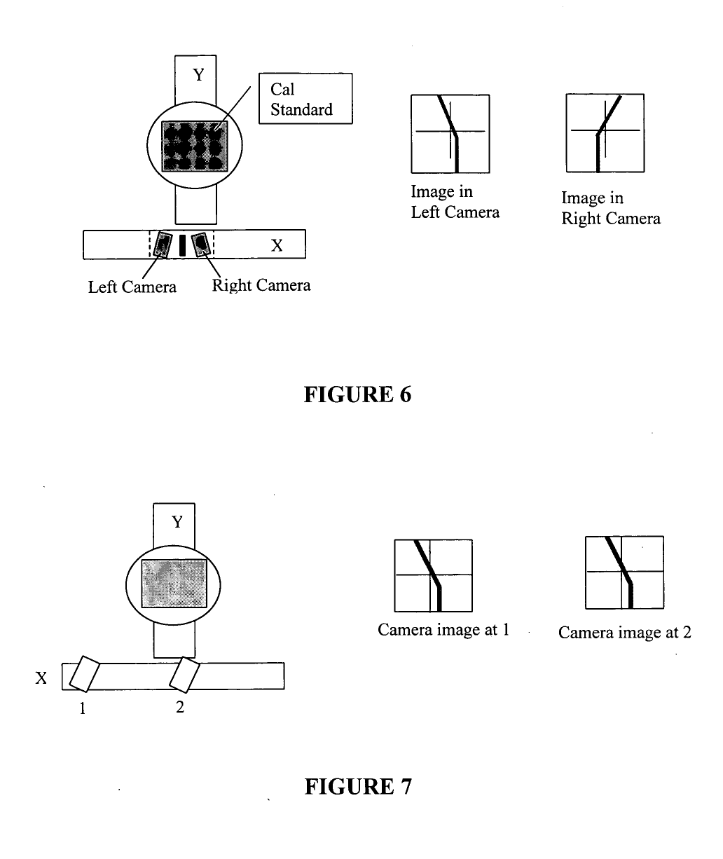

This requires an iterative process having the following steps: (1) Assume that the HOME position (it is to the right of the maker on face 1 of FIG. 6) is reached; (2) view the object in a camera display window in real time while the laser line generator is on; (3) capture the first laser line (preferably about 3 times to get an average position); (4) move the cameras/laser module to the right of the standard block by moving the X table a specified distance; (5) roughly calculate the rotating table 18 rotation angle and direction, and then rotate the table to this position; and (6) repeat steps 3 to 5, and use pixel distance as feedback angle until the calibration block 28 is confirmed as being parallel to the camera/laser module 20. When this alignment is completed, (Vx)y=0.

### Camera and Laser Calibrations

1. Calibration for the first (right side) camera now can proceed by calibrating the camera internal parameters using the RAC method by linear solution. (Tsai, R. Y. (1987) “A Versatile camera calibration techniques for high accuracy 3D machine Vision Metrology Using off-the-shelf TV cameras and Lenses”, IEEE J. Robotics Automation. Vol. RA-3, No. 4, pp. 323-344.) No table will move during this step.

The internal parameters, i.e. scale (Cx,Cy); center (Xc,Yc) and distortion parameter (k1 and k2 for non-linear mode, optional) describe the optical characteristics of the camera and its lens.

2. Calibrate the laser line generator parameters by (i) projecting laser lines onto multiple abutting surfaces of a single calibration block face as shown in FIGS. 4 or 5; (ii) viewing the calibration block in the camera view; (iii) moving the X table so that multiple surfaces, e.g. P1, P2, and P3 of FIG. 2, appear in the camera view; (iv) capturing a picture and use the 3 lines to calculate the distance of the laser line generator from the camera and the orientation of the laser line relative to the camera. Preferably, the process is repeated about 3 times and the results averaged to enhance reproducibility.

This procedure generates the orientation of camera optical axis: Tx, Ty, Tz; and displacement between camera and laser line generator: Td

3. Image Center Calibration is performed similar to auto-collimation. When a laser beam is pointed at a lens assembly, part of the light is reflected. Multiple reflections occur when the beam is reflected to the front and they can be observed on a piece of paper attached to the front of the laser with a small hole for the primary beam. The laser can be adjusted relative to the lens so that all reflections coincide with the primary beam, indicating that it is aligned with the optical axis. Once aligned, the camera can be turned on and the center of the light spot observed can be used as the image center. This method is commonly used in experimental optics to align lens assemblies and gives reproducible results.

Calibration of the second camera entails repeating the above process for the first camera. Most preferably the two cameras are calibrated at the same time. This will generate a set of laser and mechanical parameters for the second camera so that each camera has its own calibration parameters.

### Mechanical Calibrations 1. Calibration of X Orientation with Laser Scanning

Calibrate X table orientation (using sections P1 and P2 of FIG. 2) begins with (i) moving the X table to the left side of the calibration block where both cameras have a good image of a laser line extending across sections P1 and P2; (ii) taking images of the laser lines by the cameras; (iii) then moving the X table to the right side of the calibration block in a large move (preferably as large as possible so long as the laser line is still projected onto the P1 and P2); (iv) taking images of the laser lines by the cameras; and (v) then calculating the X orientation based on the laser line images. To reduce data noise, multiple iterations can be used. No matter how positions are set only X table movement should be allowed.

This generates [(Vx)x, (Vx)y, (Vx)z]; (only 2 components are independent)

To calibrate (Vx)x, (Vx)y, and (Vx)z; scan two planes (P1 and P2) and only move the X table.

The X table orientation can be calibrated with at least two edge points using the formulas:
Vxx=[(ΔX)Nx−(Xv)₁+(Xv)₂]/ΔX
Vxy=[(ΔX)Ny−(Yv)₁+(Yv)₂]/ΔX
Vxz=[(ΔX)Nz−(Zv)₁+(Zv)₂]/ΔX
wherein (ΔX) is the X table displacement, (Xv, Yv, Zv) are the edge point positions on the vision system; (Nx, Ny, Nz) are the standard defined intersection line vector (using planar sections P1 and P2 of FIG. 2).

The derivation of this relationship is presented in detail.

Assume that the plane equations for planar section 1 and planar section 2 are:
Plane 1: nx1*x+ny1*y+nz1*z=d1 (1)
Plane 2: nx2*x+ny2*x+ny2*y+nz2*z=d2 (2)
where plane normal (nx, ny, nz) and offset (d) are given. The combination of Eq. (1) and (2) also represents the equation of the straight line that is the intersection of the two planar sections P1 and P2.

Assume the orientation of the intersection line is (nx,ny,nz) that is the cross product of two plane normal (nx, ny, nz)=(nx1, ny1, nz1)×(nx2, ny2, nz2)

Assume that the laser image positions on the camera are (x,y)ij and corresponding X table encoder reading is Xj where j is the laser line index and i is the point number on the jth laser line.

Assume that the intersectional point (image point) of the laser line on the two planes is (x,y)j.

From image position (x,y)j, one can calculate corresponding 3D coordinates in the vision coordinate (Xv,Yv,Zv)j based on the camera calibration parameters.

(Xv,Yv,Zv)−>is given by camera parameters and laser parameters

The relation between vision coordinate and the world coordinate then is:
Xw=(Xv)+(Vxx)(X)
Yw=(Yv)+(Vxy)(X) (3)
Zw=(Zv)+(Vxz)(X)
wherein X is the X table position.

Assume there are two such image points (x,y)1 and (x,y)2 on the edge (or intersection of two planes) that can be determined by intersecting two fitted image lines).

Thus, the orientation of the edge can be determined by the two 3D points
Nx=[(Xw)1−(Xw)2]/(ΔX)
Ny=[(Yw)1−(Yw)2]/(ΔX)
Nz=[(Zw)1−(Zw)2]/(ΔX)
and the X table orientation can be calculated by the formulas stated above.

Discussion on Accuracy: Since the calibration edge is pretty much in parallel with the X table orientation when the vision system moves, the two image positions (x,y)1 and (x,y)2 are very close. So are the coordinate in vision system (Xv,Yv,Zv)1 and (Xv,Yv, Zv)2. Therefore the error from laser and camera parameters will have little impact on the accuracy of (Vxx, Vxy, Vxz). If desired, additional points can be used to increase the reliability and reduce measurement noise.

2. Calibration of Y Table Orientation with Laser Scanning

To calibrate (Vyx, Vyy, Vyz) given (Vxx, Vxy, Vxz) and (Vzx, Vzy, Vzz), move Y and X tables simultaneously to keep the calibration edge points in the camera view and the intersection between planar sections P6 and P7 is used. (A) Move X, Y and Z so that the left portion of sections P6 and P7 are shown in the camera view; (B) turn on the laser line generator; (C) capture laser lines while moving X and Y slides so that the laser position is focused in the camera; (D) detect laser lines and find the intersection line of sections P6 and P7; and (E), use the intersection line to calculate Y slide orientation. This generates [(Vy)x, (Vy)y, (Vy)z]; (2 independent parameters).
Vyx=[(ΔX)Nx−(Xv)₁+(Xv)₂−Vxx(ΔX)−Vzx(ΔZ)]/ΔY
Vyy=[(ΔX)Ny−(Yv)₁+(Yv)₂−Vxy(ΔX)−Vzy(ΔZ)]/ΔY
Vyz=[(ΔX)Nz−(Zv)₁+(Zv)₂]−Vxz(ΔX)−Vzz(ΔZ)]/ΔY
where X is the X table position.

3. Calibration of Z Table Orientation with Laser Scanning

To calibrate (Vzx, Vzy, Vzz) given (Vxx, Vxy, Vxz), the vision system is moved up (ΔZ) along the Z table and the intersection between planar sections P3 and P4 is used.

Move X and Y tables to their home positions and Z table up so that sections P4 and P5 can be seen by the camera (show in camera view). In this position, the camera has a view of the upper left corner of the calibration standard; (B) capture laser line and move X slide to the right; (C) detect laser lines and calculate the intersection line of Sections P4 and P5; (D) use the intersection line to calculate Z orientation.
Vzx=[(ΔX)Nx−(Xv)₁+(Xv)₂−Vxx(ΔX)]/ΔZ
Vzy=[(ΔX)Ny−(Yv)₁+(Yv)₂−Vxy(ΔX)]/ΔZ
Vzz=[(ΔX)Nz−(Zv)₁+(Zv)₂−Vxz(ΔX)]/ΔZ
where (ΔX) is the X table displacement, (Xv, Yv, Zv) are the edge point position on the vision system, (Nx, Ny, Nz) is the vector of the intersection line of planar sections P3 and P4 of FIG. 2.

4. Calibration of Rotation Center and Orientation of the Turntable

Use sections P15 and P12 (the one behind P1) of FIG. 2 to calibrate the rotation center. Assume that the parameters for section P15 and plane P12 are (nx15, ny15, nz15, d15) and (nx12, ny12, nz12, d12),that are given.

(A) Move X, Y, Z and rotation table (90 degrees) so that sections P14 and P15 are in parallel to the X slide and the camera views the upper right side of the calibration block where it abuts sections P4 and P5. (B) Turn the laser on and detect laser while moving the X slide to the left to scan Section P14 and P15. (C) Calculate the vector of the intersection line of P14 and P15. (D) Calculate the center and orientation of the calibration block.

Scan these two planar sections and do planar section fitting to get planar section parameters (nx15′,ny15′,nz15′,d15′)and(nx12′,ny12′,nz12′,d12′). The rotation center (x0, y0) is calculated by the following equations:
d15′=(nx15*cθ1+ny15*sθ1−nx15)*x0+(−nx15*sθ1+ny15*cθ1−ny15)*y0+dd15
d12′=(nx12*cθ2+ny12*sθ2−nx12)*x0+(−nx12*sθ2+ny12*cθ2−ny12)*y0+dd12
where cθ=cos(θ) and sθ=sin(θ) are known and
dd15=d15−nx15*Vyx*ΔY15−ny15*Vyy*ΔY15−nz15*Vyz*ΔY15
dd12=d12−nx12*Vyx*ΔY12−ny12*Vyy*ΔY12−nz12*Vyz*ΔY12

The rotation axis can be determined by the cross product of two or more rotated planar sections:
(nx,ny,nz)r=(nx15,ny15,nz15)×(nx15′,ny15′,nz15′);
or
(nx,ny,nz)r=(nx12,ny12,nz12)×(nx12′,ny12′,nz12′).

5. Final Closed Loop Adjustment

Scan every plane of the calibration block and reconstruct the standard by calculating all the corner points (first calculate all the intersection lines and then find the intersects). Use single value decomposition (SVD) error analysis to find which parameters are affected the most and adjust the corresponding parameters.

6. Verification & Analysis (Optional)

Put a standard PYRAMID in the scene with same origin as calibration block, and scan the pyramid by moving all tables. (Use of a sphere is not recommended as only the rotation table needs to be adjusted for sphere imaging). The measured model will be compared against the known pyramid parameters and an SVD analysis will be performed to find out which parameters contribute to the errors significantly. These corresponding parameters may be recalibrated

1. A 3D scanner calibration block having four side faces, a top and a bottom, wherein two abutting side faces each contain at least five planar sections arranged as follows:
(i) two non-abutting planar sections are perpendicular to the bottom;
(ii) two abutting planar sections are perpendicular to each other and neither is perpendicular to the bottom,
(iii) a fifth planar section is parallel to one of non-perpendicular-to-the-bottom planar sections; and
wherein one of the abutting sides further includes a camera calibration grid at a known location and perpendicular to the bottom.

2. The 3D scanner calibration block of claim 1, wherein the camera calibration grid is located such that a camera can move along only the X axis to view an intersection line between one of the perpendicular-to-the bottom planar sections and one of the non-perpendicular-to-the-bottom planar sections.

3. The 3D scanner calibration block of claim 1, wherein the two abutting side faces form a corner and are at an angle of about 110 to 160 degrees to each other.

4. The 3D scanner calibration block of claim 3, wherein the angle is about 125 to 145 degrees.

5. The 3D scanner calibration block of claim 3, wherein the angle is about 135 degrees.

6. The 3D scanner calibration block of claim 1, wherein the two abutting planar sections which are perpendicular to each other and not perpendicular to the bottom are located between the two non-abutting planar sections which are perpendicular to the bottom.

7. The 3D scanner calibration block of claim 6, wherein the planar section parallel to one of non-perpendicular-to-the-bottom planar sections is

8. A 3D scanner calibration system comprising 2 cameras and a line generator, wherein the 2 cameras and the line generator are maintained in a fixed relationship to each other, in combination with a calibration block;
said calibration block having four side faces, a top and a bottom, wherein two abutting side faces each contain at least five planar sections arranged as follows:
(i) two non-abutting planar sections are perpendicular to the bottom;
(ii) two abutting planar sections are perpendicular to each other and neither is perpendicular to the bottom,
(iii) a planar section is parallel to one of non-perpendicular-to-the-bottom planes; and
wherein one of the abutting sides further includes a camera calibration grid at a known location and perpendicular to the bottom.

9. The system of claim 8, wherein the line generator is a laser line generator.
